(19) United States
(12) Patent Application Publication
(10) Pub. No.: US 2013/0287962 A1
(43) Pub. Date: Oct. 31, 2013

(54) ELECTROSPRAY ATOMIZATION ELECTRODE, NOZZLE, APPARATUS, METHODS AND APPLICATIONS

(71) Applicants: Weiwei Deng, Oviedo, FL (US); Brandon Lojewski, Orlando, FL (US); Johan Rodriguez, Orlando, FL (US)

(72) Inventors: Weiwei Deng, Oviedo, FL (US); Brandon Lojewski, Orlando, FL (US); Johan Rodriguez, Orlando, FL (US)

(73) Assignee: University of Central Florida Research Foundation Inc., Orlando, FL (US)

(21) Appl. No.: 13/869,447

(22) Filed: Apr. 24, 2013

Related U.S. Application Data
(60) Provisional application No. 61/638,095, filed on Apr. 25, 2012.

(51) Int. Cl. B05B 5/025; B05D 1/04

(52) U.S. Cl. CPC B05B 5/025; B05D 1/04
USPC 427/458; 239/695; 204/600

(57) ABSTRACT

A multiplexed emitter source distributor electrode, a related multiplexed electrospray nozzle, a related multiplexed electrospray apparatus and a related coating method that uses the multiplexed electrospray apparatus are all predicated upon at least one of: (1) a linear emitter source density greater than about 15 emitter sources per centimeter; and (2) an area emitter source density greater than about 225 emitter sources per square centimeter. The distributor electrode comprises other than a silicon material (i.e., a metal, metal alloy, ceramic or polymer material). The distributor electrode may be fabricated using a computerized numerical control method that provides the coating method with enhanced uniformity. The nozzle and the apparatus may also use a stepped slotted extractor electrode.

### CROSS-REFERENCE TO RELATED APPLICATION

This application is related to, and derives priority from, U.S. Provisional Patent Application Ser. No. 61/638,095, filed 25 Apr. 2012 and titled Electrospray Atomization Nozzle, Apparatus, Methods and Applications, the content of which is incorporated herein fully by reference.

### STATEMENT OF GOVERNMENT INTEREST

No U.S. Government interest.

### BACKGROUND

1. Field of the Invention

Embodiments relate generally to electrospray atomization electrodes, nozzles, apparatus and methods. More particularly embodiments relate to enhanced performance electrospray atomization electrodes, nozzles, apparatus and methods.

2. Description of the Related Art

Electrospray nozzles, related apparatus and related methods are relatively well known in the materials coatings arts insofar as such electrospray nozzles, related apparatus and related methods generally provide for improved materials coatings characteristics. Since electrospray coating technology is likely to remain a popular coating technology, desirable are improvements and enhancements to electrospray nozzles, related apparatus and related methods.

### SUMMARY

Embodiments relate to: (1) at least one of a distributor electrode and an extractor electrode for a multiplexed electrospray nozzle; (2) an electrospray apparatus that includes the multiplexed electrospray nozzle that includes the at least one of the distributor electrode and the extractor electrode; (3) methods for fabricating the distributor electrode in particular; (4) methods for using the multiplexed electrospray nozzle and the electrospray apparatus to coat a liquid material upon a substrate; and (5) applications of the multiplexed electrospray nozzle and the electrospray apparatus with respect to coating the liquid material upon the substrate.

A particular embodied multiplexed electrospray nozzle and the particular embodied electrospray apparatus include a stepped slot aperture within an extractor electrode with respect to a plurality of liquid emitter sources within a distributor electrode separated from the extractor electrode, rather than a coaxial circular aperture within the extractor electrode with respect to each liquid transport emitter source within the distributor electrode separated from the extractor electrode, to provide the multiplexed electrospray nozzle and the electrospray apparatus less susceptible to clogging and thus provide superior and more uniform coating performance, particularly with respect to more viscous coating materials. The particular extractor electrode that includes the stepped slot aperture includes: (1) a reduced thickness (i.e., no greater than about 1 millimeter and more preferably no greater than about 0.5 millimeter) nearer to, and generally surrounding, the slot, to optimize electrostatic extraction properties of the extractor electrode; and (2) an increased thickness (i.e., at least about 3 millimeters and preferably at least about 5 millimeters) further from the slot, to optimize mechanical properties of the extractor electrode. The particular stepped slotted aperture includes a step distance in the plane of the extractor electrode from about 1 to about 2 millimeters. The stepped geometry of the extractor electrode provides a gradual transition from the thin section near the slot aperture to the thicker, more mechanically robust section further from the slot aperture.

More generally, an embodied distributor electrode for use within a multiplexed electrospray nozzle is fabricated with at least one of: (1) a linear emitter source density greater than about 15 emitter sources per centimeter; and (2) an area emitter source density greater than about 225 emitter sources per square centimeter, while fabricated from a material other than a silicon material (i.e., other than a silicon wafer). Such materials other than silicon materials may include, but are not necessarily limited to, metals, metal alloys, ceramics and polymers. This embodied distributor electrode may be fabricated using computerized numerical control technology to provide the distributor electrode with the foregoing linear emitter source density or area emitter source density while being fabricated from other than a silicon material.

Embodiments thus also provide a simple, rapid, and low cost approach of fabricating a compact multiplexed electrospray nozzle that includes a distributor electrode that includes the linear or area emitter source array using a precision computerized numerical control (CNC) machining platform. In comparison with silicon micro fabrication, the precision computerized numerical control machining platform process offers the flexibility of fabricating high packing density electrospray nozzle devices from a wide range of materials beyond silicon, including metals and polymers. Additionally, with CNC machining electro spray nozzle arrays can be manufactured to larger widths and areas (up to meters width or square meters area) than the width and area accessible by silicon microfabrication, which is generally limited to the available silicon wafer sizes (currently typically 300 millimeters diameter). Moreover, as indicated above, the embodiments include a stepped slot-extractor design that makes the multiplexed electrospray nozzle and electrospray apparatus operation more stable and robust. Experimentally, one may secure up to at least about 500 multiplexed electrospray emitter sources per square centimeter on the distributor electrode, with uniform primary droplet diameter from emitter source to emitter source.

A particular extractor electrode for use within a multiplexed electrospray nozzle comprises a a plate including a stepped slot wherein: (1) the plate includes a thinner portion nearer to and surrounding the stepped slot; and (2) the plate includes a thicker portion further from the stepped slot.

A particular distributor electrode for use within a multiplexed electrospray nozzle comprises a plate comprising a material selected from the group consisting of metal, metal alloy, ceramic and polymer materials, but not a silicon material. The particular distributor electrode also includes an array of emitter sources integral with the plate and comprising (or formed of) the same material as the plate, each emitter source providing a liquid pathway with respect to a liquid reservoir, the array of emitter sources having at least one of: (1) a linear density greater than about 15 emitter sources per centimeter; and (2) an area density greater than about 225 emitter sources per square centimeter.

A particular multiplexed electrospray nozzle in accordance with the embodiments includes a distributor electrode comprising: (1) a plate comprising a material selected from the group consisting of metal, metal alloy, ceramic and polymer materials, but not a silicon material; and (2) an array of emitter sources integral with the plate and comprising the same material as the plate, each emitter source providing a liquid pathway with respect to a liquid reservoir, the array of emitter sources having at least one of: (a) a linear density greater than about 15 emitter sources per centimeter; and (b) an area density greater than about 225 emitter sources per square centimeter. The particular electrospray nozzle also includes an extractor electrode positioned separated from the distributor electrode and including at least one extractor aperture that is associated with at least one emitter source within the array of emitter sources.

A particular coating method in accordance with the embodiments includes providing an electrospray apparatus comprising: (1) a distributor electrode comprising: (a) a plate comprising a material selected from the group consisting of metal, metal alloy, ceramic and polymer materials, but not a silicon material; and (b) an array of emitter sources integral with the plate and comprising the same material as the plate, each emitter source providing a liquid pathway with respect to a liquid reservoir, the array of emitter sources having at least one of: (i) a linear density greater than about 15 emitter sources per centimeter; and (ii) an area density greater than about 225 emitter sources per square centimeter; (2) an extractor electrode positioned separated from the distributor electrode and including at least one extractor aperture that is associated with at least one emitter source within the array of emitter sources; and (3) a collector electrode positioned further separated from the extractor electrode. This particular method also includes coating a liquid from the liquid reservoir onto a substrate coupled with the collector electrode while applying a (progressively increasing or decreasing) series of electric potentials upon the distributor electrode, the extractor electrode and the collector electrode.

### BRIEF DESCRIPTION OF THE DRAWINGS

The objects, features and advantages of the embodiments are understood within the context of the Detailed Description of the Embodiments, as set forth below. The Detailed Description of the Embodiments is understood within the context of the accompanying drawings, which form a material part of this disclosure, wherein:

FIG. 1 shows a distributor-extractor-collector configuration of a multiplexed electrospray nozzle and related apparatus in accordance with the embodiments.

FIG. 2 shows (a) Si planar emitter sources; (b) Al planar emitter sources; (c) brass linear emitter sources; and (d) polycarbonate linear emitter sources, for use within a multiplexed electrospray nozzle and related apparatus. The emitter sources have 120 μm OD, 50 μm ID, 300 μm height and 500 μm pitch, for a multiplexed electrospray nozzle and related apparatus in accordance with the embodiments.

FIG. 3 shows a schematic diagram of the geometry of a linear multiplexed electrospray nozzle array model for a multiplexed electrospray apparatus in accordance with the embodiments.

FIG. 4 shows a numerical simulation of the electric field magnitude for (a) a hole extractor electrode; and (b) a slot extractor electrode, for a multiplexed electrospray nozzle and related apparatus in accordance with the embodiments.

FIG. 5 shows an x-z spray profile from: (a) a numerical simulation; (b) an experiment; and (c) equation (3), for a multiplexed electrospray nozzle and related apparatus in accordance with the embodiments.

FIG. 6 shows a y-z spray profile from: (a) a numerical simulation; and (b) an experiment, for a multiplexed electrospray nozzle and related apparatus in accordance with the embodiments.

FIG. 7 shows droplet size across a 51-emitter source multiplexed electrospray nozzle array at flow rates of 0.3, 0.5 and 0.7 mL/h/emitter source, in accordance with the embodiments.

FIG. 8A shows a multiplexed electrospray nozzle within a related apparatus in accordance with the embodiments.

FIG. 8B shows a schematic diagram of an assembled multiplexed electrospray nozzle within the related apparatus in accordance with the embodiments.

FIG. 9 shows a break-away schematic diagram of a multiplexed electrospray nozzle in accordance with the embodiments.

FIGS. 10A, 10B and 10C show a series of mechanical print diagrams illustrating a slotted extractor electrode plate for a multiplexed electrospray nozzle and related apparatus in accordance with the embodiments.

### DETAILED DESCRIPTION OF THE EMBODIMENTS

### 1. GENERAL CONSIDERATIONS

Embodiments provide a multiplexed electrospray nozzle for use within a multiplexed electrospray apparatus where the multiplexed electrospray nozzle may include a stepped slotted extractor electrode with respect to a plurality of distributor electrode emitter sources. Use of such a stepped slotted extractor electrode with respect to the plurality of distributor electrode emitter sources provides the multiplexed electrospray nozzle and the multiplexed electrospray apparatus with enhanced performance, and in particular increased resistance to clogging of the stepped slotted extractor electrode. The stepped aspects of the stepped slotted extractor electrode (which is thinner nearer and surrounding the slot and thicker further from the slot) allow for optimization of electric field (due to thinness nearer and surrounding the slot) within the context of mechanical stability (due to thickness further from the slot).

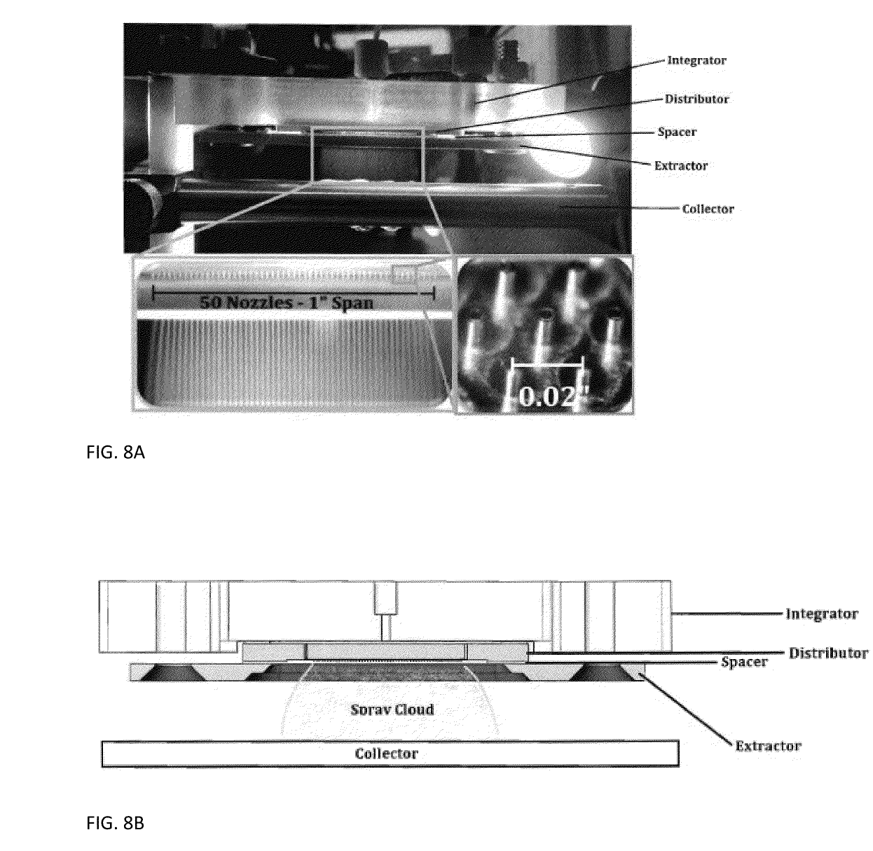

For example, FIG. 8A shows an image of a multiplexed electrospray apparatus including a multiplexed electrospray nozzle in accordance with the embodiments. In particular the multiplexed electrospray apparatus includes an integrator (for fluid connection to a liquid feed line and a plurality of electrode connections to a plurality of power supply lines) to which is attached and assembled a distributor electrode (which provides for individual emitter sources), a spacer and an extractor electrode. Finally, the multiplexed electrospray apparatus in accordance with the embodiments includes a collector electrode (i.e., which is also intended to include coupled thereto and integral thereto a substrate to be coated) separated from the extractor electrode. Moreover, FIG. 8B shows a schematic diagram of the assembled multiplexed electrospray nozzle in accordance with the embodiments as illustrated in FIG. 8A, but with greater detail.

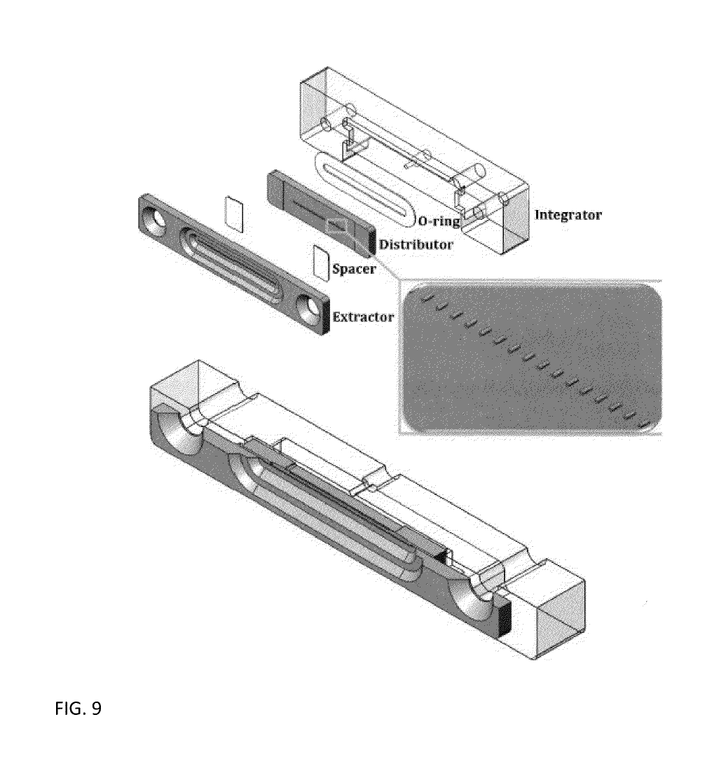

Correlating with FIG. 8B, FIG. 9 shows a break-away schematic diagram of a multiplexed electrospray nozzle in accordance with the embodiments. Notable within FIG. 9 is the integrator which includes a fluid chamber reservoir which supplies to each emitter source within the distributor electrode a fluid to be coated upon a substrate. Also illustrated in FIG. 9 is an O-ring seal for the integrator with respect to the distributor electrode, as well as additional spacers for the distributor electrode with respect to the extractor electrode. Also present within the integrator are multiple and concealed high voltage connections to at least the distributor electrode and the extractor electrode, although such high voltage connections are not particularly illustrated. Thus, the integrator is also intended as an electrically insulating component that provides a fluid sealing connection point between a fluid feed line and the fluid chamber reservoir within the integrator. As is further illustrated in FIG. 9, the distributor electrode is adjustable with respect to the extractor electrode and the integrator, where the integrator and the extractor electrode are not adjustable with respect to each other. Such adjustability of the distributor electrode provides for ease of adjustment and alignment of a multiplexed electrospray nozzle in accordance with the embodiments at or near the last stage in assembly thereof. Finally, the integrator provides a uniform mechanical mounting point for a multiplexed electrospray nozzle in accordance with the embodiments to a multiplexed electrospray apparatus within any of several industrial applications (i.e., a multiplexed electrospray nozzle in accordance with the embodiments is readily adaptable to various multiplexed electrospray apparatus). The integrator may possess any number of, or all of, the foregoing characteristics and features.

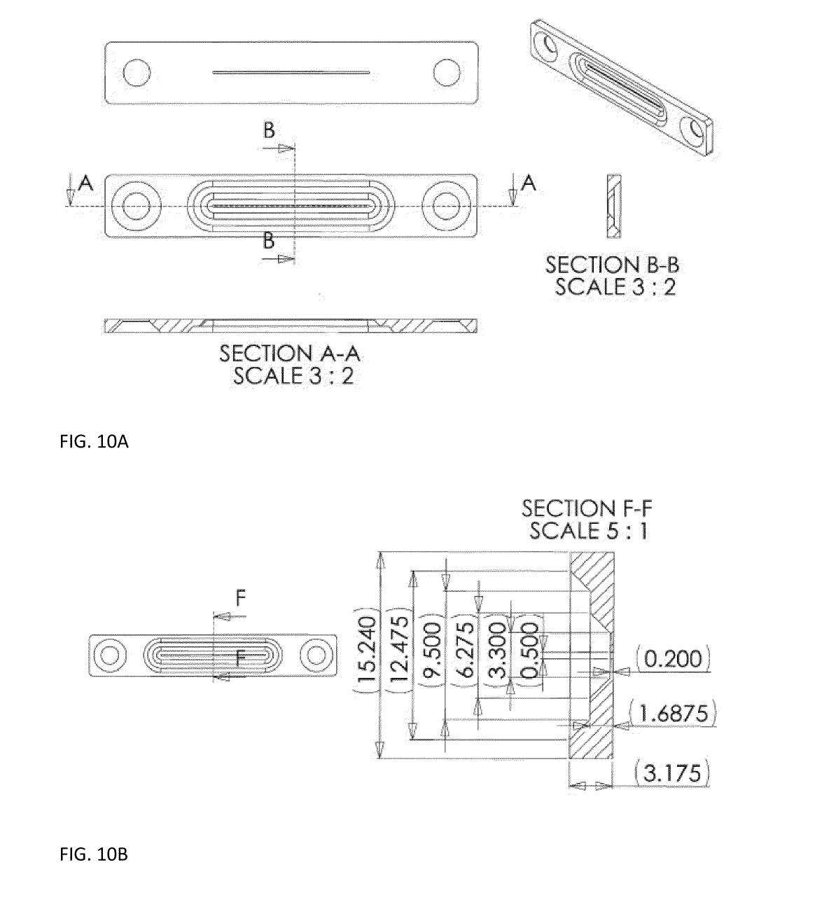

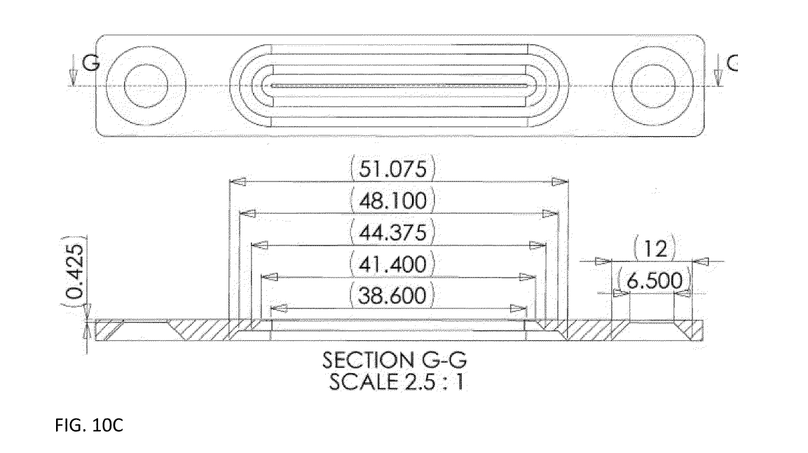

For further example, FIG. 10A, FIG. 10B and FIG. 10C provide a series of schematic print drawing diagrams illustrating a multi-stepped slotted extractor electrode for use within a multiplexed electrospray nozzle and related apparatus in accordance with the embodiments. It may be noted that the stepped slotted extractor electrode includes: (1) a thinner portion nearer to and surrounding the slot in order to provide more optimal electric field for spray operation; and (2) a thicker portion further from the slot in order to provide more optimal mechanical characteristics of the extractor electrode.

In accordance with the foregoing descriptions of FIG. 8A, FIG. 8B, FIG. 9, FIG. 10A, FIG. 10B and FIG. 10C, the embodiments first consider a distributor electrode that includes a plate that further includes integral thereto a plurality of emitter sources in the form of apertures within the distributor electrode plate. The distributor electrode and an extractor electrode when assembled next comprise a multiplexed electrospray nozzle. The distributor electrode, the extractor electrode and the collector electrode when assembled further comprise a multiplexed electrospray apparatus.

Embodiments also provide that the distributor electrode within the multiplexed electrospray nozzle in accordance with the embodiments may be fabricated from a material other than a silicon material (i.e., a silicon wafer) while using other than MEMS microfabrication processing techniques such as photolithography and chemical etching. Such materials other than silicon wafers may include, but are not limited to metals, metal alloys, ceramics and polymers. In particular, computerized numerical control processing may yield an embodied distributor electrode within a multiplexed electrospray nozzle with a linear emitter source density greater than about 15 emitter sources per centimeter (more preferably greater than about 25 emitter sources per centimeter and still more preferably greater than about 35 emitter sources per centimeter) or alternatively an area emitter source density greater than about 225 emitter sources per square centimeter (more preferably greater than about 625 emitter sources per square centimeter and still more preferably greater than about 1225 emitter sources per square centimeter). Such processing may also yield a multiplexed electrospray nozzle (or more particularly a distributor electrode as a single component) with at least one area dimension (i.e., a length dimension or a width dimension) greater than 300 millimeters (to which silicon wafer materials are generally currently dimensionally limited). Even greater area dimensions of at least about 500 millimeters or at least about 1000 millimeters for a distributor electrode as a single component are even more desirable in some applications.

Within the embodiments, particular emitter sources may have: (1) an inside diameter less than about 50 microns and preferably less than about 40 microns; (2) an outside diameter less than about 100 microns and preferably less than about 80 microns; (3) a separation distance less than about 250 microns and preferably less than about 200 microns; and (4) a height more than about 100 microns and preferably more than about 200 microns.

The embodiments also provide for considering within the context of a slot extractor electrode the use of dummy emitter sources at a periphery of a linear array of distributor electrode emitter sources or a planar array of distributor electrode emitter sources to maintain a symmetric electric field for the edge emitter sources.

The embodiments also provide for considering within the context of a distributor electrode that a viscous pressure drop through a distributor electrode channel (governed by the Hagen-Poiseuille flow solution) is desirably comparable to the electrohydrodynamic pulling pressure of a particular fluid to be coated using a multiplexed electrospray nozzle that includes the distributor electrode. The electrohydrodynamic pulling pressure is moreover further comparable to γ/OD, where γ is the surface tension coefficient of the liquid, and OD is the nozzle outer diameter. Thus, for emitter source design purposes, the viscous pressure drop for a particular liquid material to flow through the electrospray nozzle inner diameter ID must be greater than the electrohydrodynamic pulling pressure in order to maintain the proper flow rate required for operation of the electrospray.

For further clarification within the context of the above, a viscous flow pressure is generally primarily only related to the ID of an emitter source. The OD of an emitter source is related to an onset voltage for an electrospray nozzle emitter source. For a fixed electric potential difference, a smaller OD produces a stronger electric field gradient. This OD dependence on the onset voltage has been studied and is described through the Smith Relation (i.e., see equation 4 in Smith, IEEE Trans. On Industry Applications, vol. 1A-22, No. 3, May/June 1986, which is incorporated herein by reference to the extent allowed). This provides a practical rule of thumb that a smaller OD is more suited for high surface tension liquids, and that a smaller OD enables an onset voltage below the point of static discharge.

### 2. DEVICE DESIGN, FABRICATION, MODELING AND CHARACTERIZATION

2.1 Electrode and Fluidic Design

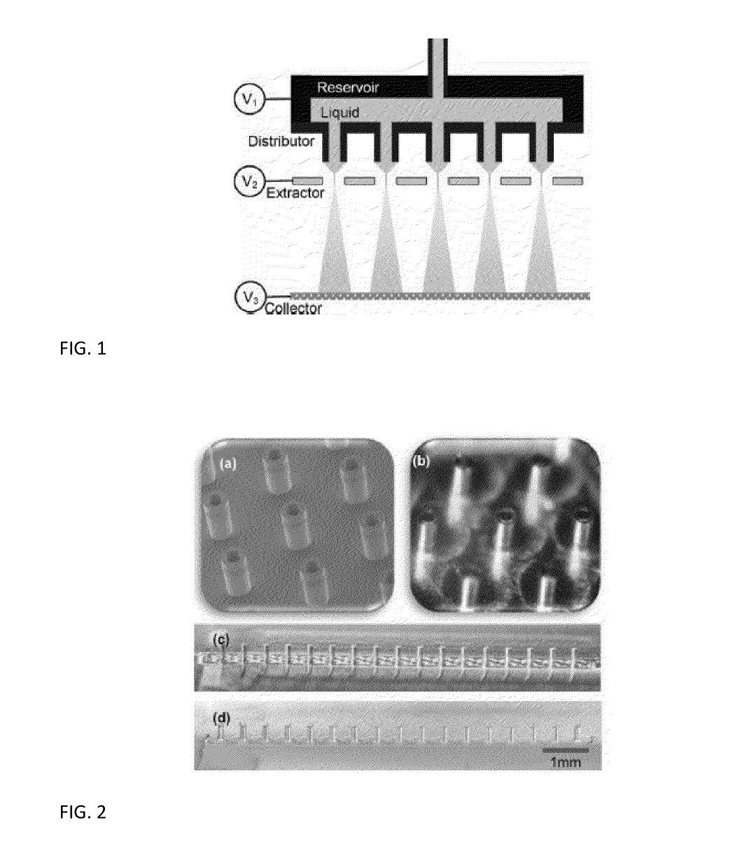

To attain identical operation from emitter source to emitter source within a multiplexed electrospray nozzle, localized and equal electric field around each emitter source is crucial. Previous successful multiplexed electrospray nozzle devices achieved operation in the cone-jet mode at high source packing densities by using the distributor-extractor-collector configuration, effectively separating the multiplexed electrospray nozzle device into two isolated electric field regions: (1) the cone-jet forming region; and (2) the spray region, as illustrated in FIG. 1. The distributor electrode is the emitter source bearing electrode which initiates the spray by uniformly dividing the flow to each emitter source tip where cone-jets form. The extractor electrode is an electrostatic barrier electrode between the distributor electrode and the collector electrode that protects the vulnerable cone-jet forming region from the space charge created by droplets in the spray region. The collector electrode is the electrode furthest downstream which accelerates the droplets towards a substrate which is coupled to (i.e., generally located upon or over) the collector electrode.

A good electrode design should also address the “edge effect,” which refers to the observation that the emitter sources at the edge of an emitter source array experience more intense electric field and “pull” more liquid flow rates at the edge emitter sources. The higher flow rates at the edge will lead to significantly larger droplet diameters and should be avoided. The strategy used within the embodiments is to introduce extra dummy emitter sources (i.e., posts without a microfluidic channel) on the edge, which offset the edge effect and further improve the electric field uniformity.

One may focus on creating compact linear arrays of emitter sources, insofar as numerical simulation has shown that to achieve uniform deposition using multiplexed electrospray methodology it is best to use a linear emitter source array combined with a linear motion of a substrate.

As illustrated above, for the extractor electrode, one may adopt a slot geometry over hole geometry for simpler alignment and better resistance to liquid flooding at the extractor electrode.

A fluidic design for a nozzle including a distributor electrode in accordance with the embodiments was guided by a design rule that states that if approximately equal flow fields are desired for all emitter sources, the viscous pressure drop through the channel (governed by the Hagen-Poiseuille flow solution) must be comparable to the electrohydrodynamic pulling pressure, which in turn is comparable to γ/OD, where γ is the surface tension coefficient of the liquid to be coated, and OD is the emitter source outer diameter. Thus, an OD of an emitter source may be determined if values for other variables are known. Meanwhile, the fluidic design needs to be compatible with the geometry of the machining tools. Commercial tungsten carbide drills and endmills are available in the micron size range with aspect ratios up to 10:1, for a nozzle inner diameter ID=50 μm, micro-channel length L =500 μm, and outer diameter OD=120 μm. One may verify that those geometries satisfy the above mentioned design rule with ethanol running at ˜1 ml/hr/emitter source.

2.2 Device Fabrication

To manufacture electrospray nozzle arrays over large spans, expedite the prototyping cycle, and reduce the cost associated with silicon microfabrication, one may utilize a precision machining process for nozzle fabrication. To that end, three micron level precision linear stages (Newport TS-series) were retrofit with 36:1 geared stepper motors, and assembled into an XYZ configuration with 1 μm space resolution. In addition, also integrated was a precision high-speed spindle (NSK) capable of 25,000 RPMs which was mounted onto the platform. 50 μm diameter microdrills and 250 μm diameter endmills (Kyocera) were used to machine the inner and outer nozzle diameters respectively. The multiplexed electrospray nozzle device was first designed using SolidWorks™ software and then the CAD model was converted to machine readable g-code using CAMWorks™ software. The g-code was executed using the open-source CNC control software (EMC2™). After machining, nozzle components were post treated by etching in a dilute HCl solution to assist removal of any remaining burrs which would cause irregularities in the electric and flow fields. Finally the nozzle components were cleaned in ethanol within an ultrasonication bath. Several examples of finished emitter source array devices are shown in FIG. 2.

2.3 Approximate Spray Profile Model

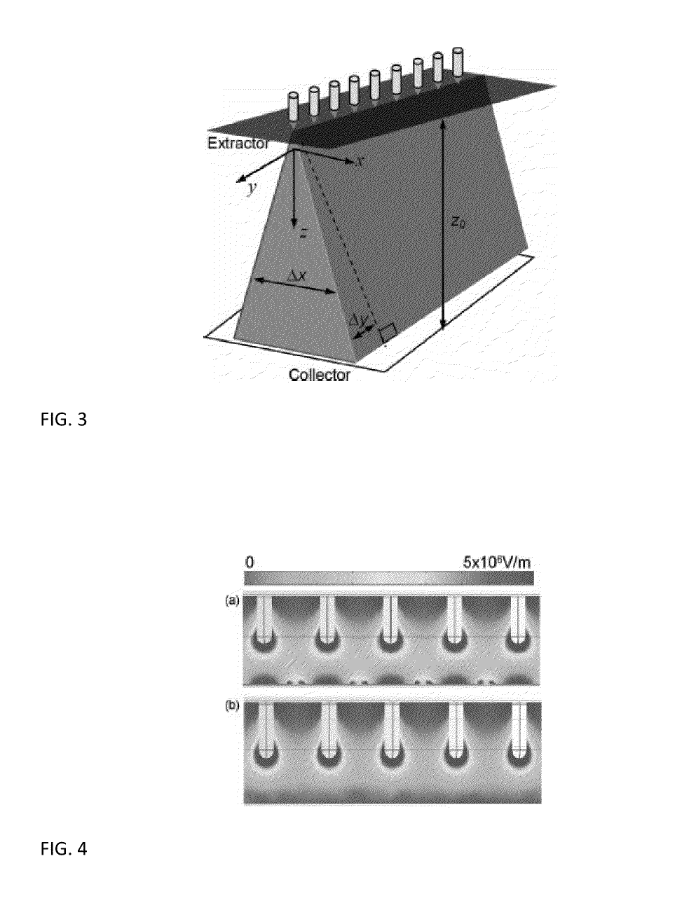

FIG. 3 shows a schematic of a linear nozzle device illustrating the orientation of the axes. One may derive a spray profile model to describe how the spray from a linear nozzle source expands along the x direction. One may make the following assumptions to simplify the real problem into a more manageable one:
i. The spray consists of monodisperse, mutually charged droplets. In other words, one only considers the primary droplets and will neglect the satellite droplets, which typically account for only ˜1% or less of the total spray mass. The droplet inertia is negligible, therefore the droplet motion is dictated by \vec{V}=Z\vec{E}, where Z is the mobility of the droplet, \vec{V} is the droplet velocity, and \vec{E} is the electric field. For an inertia-less droplet Z=q/3πμd₀, where q is the charge carried by each droplet, μ is the dynamic viscosity of the gaseous phase media and d₀ is the droplet diameter.
ii. The axial velocity of the droplet, u, is constant.
iii. The volumetric charge density ρ does not vary along the radial direction, i.e. ∂ρ/∂r=0.
iv. The x component of the space charge field, \vec{E}_{ρ}, is negligible compared to the magnitude of the driving field \vec{E}_{d}, which is the electric field between the extractor electrode and the collector electrode.

At steady state, the law of charge conservation is Δ·(ρ\vec{V})=0. Using \vec{V}=Z\vec{E} and Gauss's law Δ·\vec{E}=ρ/ε₀, and notice ∂ρ/∂x≈0, one may reach Zρ²/ε₀+u∂ρ/∂z=0. The solution to this equation is:

$$\frac{1}{ρ} - \frac{1}{{ρ}_{0}} = \frac{Z}{{ɛ}_{0} u} z , \qquad ( 1 )$$

where ρ₀=ρ(z=0), or at the exit of the extractor. Initially the droplets are linearly aligned right after cone-jet breakup, making ρ₀ a very large value and 1/ρ₀ negligible compared to 1/ρ. If one assumes that the spray does not expand significantly along the y direction, one has:

ρ=NI₀/(NP₀·2x·u)=I₀/(2P₀xu), (2)

where P₀ is the distance between two neighboring emitter sources. Since u=E_{d}·Z, Eq. (2) becomes:

$$Δ x = \frac{{I}_{0}}{2 {P}_{0} {ɛ}_{0} {ZE}_{d}^{2}} z , \qquad ( 3 )$$

where Δx is the width of the spray at a distance z from the extractor electrode. Eq. (3) suggests that the projection of spray on x-z plane resemble an isosceles triangle.

The y-expansion is primarily determined by the spray axis bending, caused by the repelling force exerted by other sprays. By approximating the spray as a line-of-charge, one may treat axis bending of the spray at the edge as the result of E_{y}, which is the radial component of the electric field introduced by all other line-of-charge:

$${E}_{y} = \frac{λ}{2 π {P}_{0} {ɛ}_{0}} {\sum }_{i = 1}^{N - 1} \frac{1}{i} \approx \frac{{I}_{0}}{2 π {P}_{0} {ɛ}_{0} u} ln ( N ) , \qquad ( 4 )$$

when N is sufficiently large. Here λ is the line charge density λ=I₀/u.

The spray axis separation velocity is:

$${u}_{y} = \frac{d y}{d t} = {E}_{y} Z = \frac{{I}_{0} ln ( N ) Z}{2 π {P}_{0} {ɛ}_{0} u} , \qquad ( 5 )$$

The solution to Eq. (5) is:

$$Δ y = \frac{{I}_{0} ln ( N )}{2 π {P}_{0} {ɛ}_{0} {ZE}_{d}^{2}} z . \qquad ( 6 )$$

Eq. (6) suggests that the projection of spray on y-z plane resemble an isosceles trapezoidal.

2.4 Modeling of Minimum Driving Field

To avoid droplet fly-back, the driving field E_{d} applied between the extractor electrode and the collector electrode must exceed a critical value Eₓ, otherwise droplets will accumulate and eventually flood the extractor electrode, inhibiting operation. The value of E_{c} is equal to the maximum space charge field that appears in the “critical zone” right after the spray passes through the extractor electrode (x˜0, z˜0) at close proximity to the center of the spray. Again, one may use the line-of-charge approximation, and note the center spray as the 0^{th} spray (assuming an odd number of nozzles) while the i^{th} pair includes the two sprays at a distance iP₀ from the center. The z component field E_{c,i} near the “critical zone” caused by the i^{th} group is

$${E}_{c , i} = 2 {\int }_{0}^{{z}_{0}} \frac{λ z}{2 {{πɛ}_{0} ( {( {iP}_{0} )}^{2} + {z}^{2} )}^{3 / 2}} d z = \frac{λ / {πɛ}_{0}}{\sqrt{{( {iP}_{0} )}^{2} + {z}^{2}}} {\vert}_{0}^{{z}_{0}} = {E}_{ref} \frac{1}{i} ( 1 - \frac{1}{\sqrt{{α}^{2} / {i}^{2} + 1}} ) \qquad ( 7 )$$

where E_{ref}=λ/(πε₀P₀) and α=z₀/P₀. Because typically z₀˜10 mm, and P₀˜0.5 mm, α is on the order of 10. Since E_{c,i}<E_{ref}/i, one may estimate the upper limit of the critical field:

$${E}_{c} = {\sum }_{i = 1}^{( N - 1 ) / 2} {E}_{c , i} < {\sum }_{i = 1}^{( N - 1 ) / 2} {E}_{ref} \frac{1}{i} \approx {E}_{ref} ln ( N / 2 ) . \qquad ( 8 )$$

Using the values for line charge density λ=2×10⁻⁹ C/m, P₀=0.5 mm, and N=51, yields E_{c}=4.3 kV/cm. All of the experiments used driving fields more intense than 4.3 kV/cm.

2.5 Numerical Simulation

The numerical simulation of the spray interaction was conducted using a Lagrangian droplet tracking model executed on a GPU supercomputer. The model simulated the trajectory of all droplets just after jet break-up. A Lagrangian method has been well documented previously and the details will not be repeated here.

The electric fields generated by different electrode designs were simulated using COMSOL Multiphysics software. To model the nozzle geometry, cylinders with the same height and outer diameter as the nozzles in a 51 nozzle device were used, but spherical caps were superimposed at a tip to simulate a conductive liquid meniscus.

2.6 Device Characterization

The fluid used in this work was 200 proof ethanol with electric conductivity of 1.6×10⁻⁵ S/m. The working flow rate range was tested for pure ethanol through a single emitter source in the cone-jet mode was 0.2-1 ml/hr. The operating environment was air at atmospheric pressure. No charge neutralization mechanism was introduced.

The droplet size at each individual electrospray emitter source across the 51 electrospray emitter source array was measured using phase doppler interferometry (PDI—Artium). To measure the size and velocity of the droplets emanating from each emitter source, the device was mounted on a 3-axis micrometer to position the spray cloud in the PDI probe volume. For each spray, the laser probe volume was positioned at or near the spray axis. Although the point measurement only gave the size of the primary droplets, this size is representative because the primary droplets have dominant mass in a cone-jet electrospray. Evaluated were 2,000 primary droplet samples and recorded was the simply averaged droplet diameter D₁₀.

The spray was visualized by shining a 532 nm laser sheet on the x-z or y-z plane. The images of the spray profile were taken using a digital camera (Canon T2) with a macro lens (Sigma) at relatively long exposure time to trace the droplet trajectory.

### 3. RESULTS AND DISCUSSION

3.1 Electric Fields Comparison Between Hole Extractor and Slot Extractor

Two simulations were performed using extractors spaced 375 μm away from the tip of the emitter sources. One used an extractor with 500 μm diameter holes and another with a slot of 500 μm opening width. The boundary condition at the extractor surface was ground potential and high potential at the emitter source surface. The simulation results as illustrated in FIG. 4 show that emitter sources at potential of 1.2 kV using a hole extractor produce almost identical electric field as those emitter sources 1.3 kV using a slot extractor. The modest increase in required voltage for slot configuration is acceptable since the slot extractor brings the benefits of alignment ease and higher tolerance to accidental flooding.

3.2 Spray Profiles

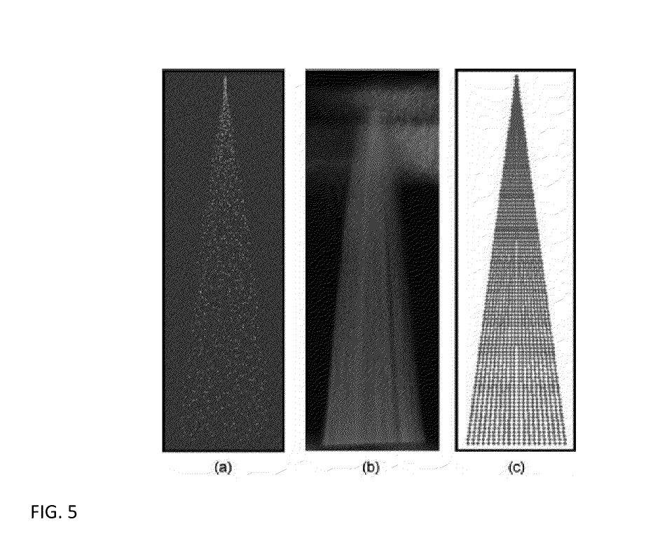

FIG. 5 shows the spray profile on the x-y plane from numerical simulation, experiment, and profile model Eq. (5). All results are in good agreement, showing the profile on x-z plane resembles an isosceles triangle.

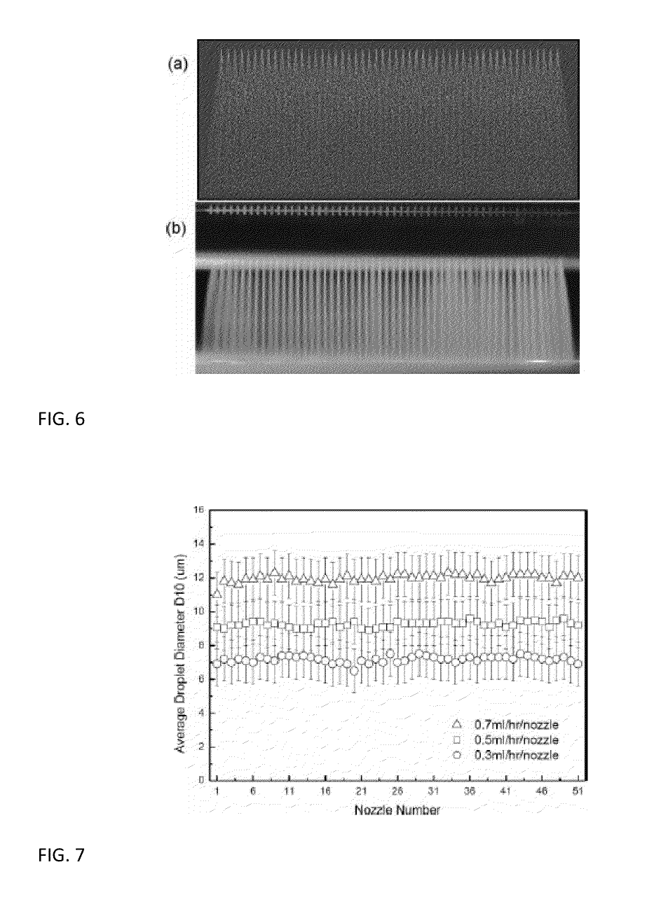

FIG. 6 shows the spray profile on the y-z plane from numerical simulation and experiment. The dark region in FIG. 6b is caused by the blockage of the extractor electrode structure. The experimental result agrees well with the simulation, showing the profile on the y-z plane resembles an isosceles trapezoidal. Moreover, for N=51, P₀=0.5 mm, the typical value of Δy is 1.7 mm, which is insignificant compared to the value of original total spray width (NP₀=25.5 mm).

3.3 Droplet Size Uniformity

FIG. 7 shows the primary droplet diameter data at each individual spray of the 51-emitter source array at 0.3, 0.5, and 0.7 ml/hr/nozzle. The uncertainty of the PDI diameter measurement is ±1.3 μm. Clearly, the average droplet diameter for each source remained uniform across the array, showing a maximum relative standard deviation of 3% at 0.3 ml/hr/nozzle. The data confirmed a high performance in terms of droplet size uniformity across all emitter sources for the linear device.

### 4. CONCLUSION

The embodiments include the design, fabrication, analysis and performance of a linear emitter source array electrospray system. The linear emitter source array is fabricated on a precision CNC micromachining platform, which produces packing densities on par with silicon microfabrication at 20 emitter sources per centimeter for linear devices and 460 emitter sources per square centimeter for a two-dimensional array. The devices show excellent primary droplet size uniformity from emitter source to emitter source, with RSD<3% at flow rates from 0.3 to 0.7 mL/h/source.

Desirably, a wide range of CNC machinable materials may be processed by this approach. For example, metals such as aluminum or brass can be used to ease the device handling since silicon is relatively fragile. Polymers such as polycarbonate can be used when the working fluid is acidic which prevents the use of metals. In addition, CNC machinable stock materials do not have the thickness limit faced by silicon wafers (about 1 mm). Thus, a multiplexed electrospray or related apparatus in accordance with the embodiments may be designed and machined for more compact systems level packaging.

CNC machining is a series process instead of parallel fabrication such as lithography. The machining time of the entire emitter source array is the product of number of emitter sources and the time needed for each emitter source. It takes about 2 min for the experimental CNC to machine a single emitter source, and about 2 h to machine the 51-emitter source array. This relatively long machining time is due to the low speed of inexpensive linear stages (about $2,000 each axis) based on lead screws and stepper motors. The machining time can be reduced by at least an order of magnitude by using high-speed, high-precision piezo linear stages, which cost about $10,000 per axis. The smallest emitter source inner diameter is limited by the finest drill commercially available (currently 25 μm). The packing density is limited by the smallest endmill available (currently 100 μm). It is also worth noticing that it is very convenient for CNC to fabricate tapered nozzles, because the 45. end mills are commercially available.

A tapered nozzle effectively makes the tip outer diameter nearly identical to the inner diameter, which can help suppress evaporation when volatile liquids or very low flow rates are required. Because of the uniform primary droplet diameter, rapid fabrication process, ease of alignment, robust operation, and a wide selection of materials, one may expect the linear devices be an emerging aerosol generation tool in many important applications such as but not limited to thin film deposition, roll-to-roll manufacturing and materials synthesis.

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A distributor electrode comprising:
a plate comprising a material selected from the group consisting of metal, metal alloy, ceramic and polymer materials, but not a silicon material; and
an array of emitter sources integral with the plate and comprising the same material as the plate, each emitter source providing a liquid pathway with respect to a liquid reservoir, the array of emitter sources having at least one of:
a linear density greater than 15 emitter sources per centimeter; and
an area density greater than 225 emitter sources per square centimeter.

2. The distributor electrode of claim 1 wherein the distributor electrode comprises at least one of a metal and a metal alloy material.

3. The distributor electrode of claim 1 wherein the distributor electrode comprises a ceramic material.

4. The distributor electrode of claim 1 wherein the distributor electrode comprises a polymer material.

5. The distributor electrode of claim 1 wherein each emitter source has:
an inner diameter less than about 50 microns;
an outer diameter less than about 100 microns;
a separation distance less than about 250 microns; and
a height greater than about 100 microns.

6. The distributor electrode of claim 1 wherein the array of emitter sources includes at least one dummy emitter source at a periphery of the array of emitter sources.

7. The distributor electrode of claim 1 wherein:
the distributor electrode is fabricated using a computerized numerical control method; and
the distributor electrode comprises a single component having at least one area dimension greater than 300 millimeters.

8. An electrospray nozzle comprising:
a distributor electrode comprising:
a plate comprising a material selected from the group consisting of metal, metal alloy, ceramic and polymer materials, but not a silicon material; and
an array of emitter sources integral with the plate and comprising the same material as the plate, each emitter source providing a liquid pathway with respect to a liquid reservoir, the array of emitter sources having at least one of:
a linear density greater than about 15 emitter sources per centimeter; and
an area density greater than about 225 emitter sources per square centimeter; and
an extractor electrode positioned separated from the distributor electrode and including at least one extractor aperture that is associated with at least one emitter source within the array of emitter sources.

9. The electrospray nozzle of claim 8 further comprising a collector electrode positioned with a side separated from the extractor electrode.

10. The electrospray nozzle of claim 8 wherein the extractor electrode comprises an array of extractor apertures that correspond with the array of emitter sources.

11. The electrospray nozzle of claim 8 wherein the extractor electrode comprises a stepped slot aperture that corresponds with a plurality of emitter sources within the array of emitter sources.

12. The electrospray nozzle of claim 8 wherein each emitter source has:
an inner diameter less than about 50 microns;
an outer diameter less than about 100 microns;
a separation distance less than about 250 microns; and
a height greater than about 100 microns.

13. The electrospray nozzle of claim 8 wherein the array of emitter sources includes at least one dummy emitter source located at a periphery of the array of emitter sources.

14. The electrospray nozzle of claim 8 wherein the extractor electrode is positioned with respect to the distributor electrode by means of an integrator component to which the distributor electrode alignment is adjustable and the extractor electrode alignment is not adjustable.

15. A coating method comprising:
providing an electrospray apparatus comprising:
a distributor electrode comprising:
a plate comprising a material selected from the group consisting of metal, metal alloy, ceramic and polymer materials, but not a silicon material; and
an array of emitter sources integral with the plate and comprising the same material as the plate, each emitter source providing a liquid pathway with respect to a liquid reservoir, the array of emitter sources having at least one of:
a linear density greater than 15 emitter sources per centimeter; and
an area density greater than 225 emitter sources per square centimeter;
an extractor electrode positioned separated from the distributor electrode and including at least one extractor aperture that is associated with at least one emitter source within the array of emitter sources; and
a collector electrode positioned further separated from the extractor electrode; and
coating a liquid coating from the liquid reservoir onto a substrate coupled to the collector electrode while applying a progressive series of potentials upon the distributor electrode, the extractor electrode and the collector electrode.

16. The method of claim 15 wherein the extractor electrode comprises an array of extractor apertures that correspond with the array of emitter sources.

17. The method of claim 15 wherein the extractor electrode comprises a stepped slot aperture that corresponds with a plurality of emitter sources within the array of emitter sources.

18. The method of claim 15 wherein each emitter source has:
an inner diameter less than about 50 microns;
an outer diameter less than about 100 microns;
a separation distance less than about 250 microns; and
a height greater than about 100 microns.

19. The method of claim 15 wherein the array of emitter sources includes at least one dummy emitter source located at a periphery of the array of emitter sources.

20. The method of claim 15 wherein the extractor electrode is positioned with respect to the distributor electrode by means of an integrator component to which the distributor electrode alignment is adjustable and the extractor electrode alignment is not adjustable.

21. The method of claim 20 wherein the integrator component further comprises at least one of:
a sealed connection point for a main liquid feed line to the liquid reservoir with respect to the distributor electrode;
an electrical connection with respect to the distributor electrode;
an electrical connection with respect to the extractor electrode; and
an electrically insulated mechanical point of mounting a multiplexed electrospray nozzle with respect to a multiplexed electrospray apparatus.

22. The method of claim 20 wherein the integrator component further comprises at least two of:
a sealed connection point for a main liquid feed line to the liquid reservoir with respect to the distributor electrode;
an electrical connection with respect to the distributor electrode;
an electrical connection with respect to the extractor electrode; and
an electrically insulated mechanical point of mounting a multiplexed electrospray nozzle with respect to a multiplexed electrospray apparatus.

23. The method of claim 20 wherein the integrator component further comprises each of:
a sealed connection point for a main liquid feed line to the liquid reservoir with respect to the distributor electrode;
an electrical connection with respect to the distributor electrode;
an electrical connection with respect to the extractor electrode; and
an electrically insulated mechanical point of mounting a multiplexed electrospray nozzle with respect to a multiplexed electrospray apparatus.

24. An extractor electrode comprising a plate including a stepped slot wherein:
the plate includes a thinner portion nearer to and surrounding the stepped slot; and
the plate includes a thicker portion further from the stepped slot.

25. The extractor electrode of claim 24 wherein:
the thinner portion has a thickness no greater than about 1 millimeter; and
the thicker portion has a thickness at least about 3 millimeters.
